(19) United States
(12) Patent Application Publication
(10) Pub. No.: US 2008/0189330 A1
(43) Pub. Date: Aug. 7, 2008

(54) Probabilistic Audio Networks

(76) Inventors: Holger H. Hoos, Vancouver (CA); Juergen Kilian, Fuerth (DE); Ronald A. Rensink, Vancouver (CA)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/793,410

(22) PCT Filed: Dec. 15, 2005
(86) PCT No.: PCT/CA05/01896

§ 371 Date: Jun. 14, 2007

Related U.S. Application Data
(60) Provisional application No. 60/636,290, filed on Dec. 15, 2004.

(51) Int. Cl. G06F 17/30; G06F 17/00

(52) U.S. Cl. 707/104.1; 707/E17.009

(57) ABSTRACT

Systems and methods for selecting media tracks for playback from among a network of accessible media tracks involve providing a probabilistic network of accessible media tracks and a current track from among the tracks in the network. The network comprises, for each individual track, a corresponding plurality of potentially subsequent tracks and a corresponding plurality of selection probabilities, each of the corresponding plurality of selection probabilities indicating a probability that an associated one of the corresponding plurality of potentially subsequent tracks is selected as a subsequent track when the individual track is the current track. The method also involves selecting a first subsequent track from among the plurality of potentially subsequent tracks corresponding to the current track in accordance with the plurality of selection probabilities corresponding to the current track.

### REFERENCE TO RELATED APPLICATIONS

This application claims priority from U.S. patent application No. 60/636,290 filed 15 Dec. 2004 which is hereby incorporated by reference herein. This application is related to the co-pending application entitled SYSTEMS AND METHODS FOR STORING, MAINTAINING AND PROVIDING ACCESS TO INFORMATION which is filed together herewith and which is hereby incorporated by reference herein.

### TECHNICAL FIELD

The invention relates to media playback systems. Particular aspects of the invention provide systems and methods for playing back audio tracks accessible to audio playback systems.

### BACKGROUND

Audio playback systems may comprise data storage (e.g. solid state memory or hard drive memory) or may have access to external data storage (e.g. an optical CD) containing audio information (e.g. musical tracks). Audio playback systems may have the ability to acquire, store, maintain and play back such audio information. In typical audio playback systems, such audio information is provided in the form of files or the like (e.g. successive tracks on an audio CD). In some systems, such files may be organized hierarchically (e.g. in folders). In some systems, groups of files may be organized into “playlists”.

In conventional audio playback systems, tracks are played back in a predetermined sequential order. For example, the tracks on an audio CD may be played in the predetermined order in which they were recorded on the CD or the tracks in a playlist may be played back in the order determined by the playlist. Sequential playback may be undesirable because of its lack of variation. This drawback with sequential playback is particularly problematic where the playlist (e.g. a set of audio tracks) is looping on a frequent basis or many times over, such as in car stereo systems or in the background music systems of shopping centers and restaurants.

Conventional audio playback systems may also have a “random” playback mode. However, the random modes in conventional audio playback systems are typically oblivious to a set of audio tracks comprising different types of tracks. For example, an audio playback system may have access to a set of available audio tracks which includes some music tracks that are suitable for background music in a shopping mall (e.g. holiday music or music containing softer sounds) and some musical tracks that are not suitable for background music in a shopping mall (e.g. aggressive sounding music). Typically, the random playback modes of conventional audio playback devices do not discriminate between these types of tracks and a user is forced to create a playlist containing a subset of the available tracks.

Similarly, a user may be in the mood for a certain feel of music (e.g. music from related genres, music from related artists or music that is otherwise related), but does not want to sort through all of his or her hierarchically organized audio files to assemble a new playlist. For example, a person may want to listen to a mix of jazz and blues. Some audio playback systems provide the ability to play back tracks which have a particular artist or which have a particular genre. However, conventional audio playback systems do not provide the ability to automatically play back tracks from related genres or related artists without creating a completely new playlist.

Given the increasing volume of digital audio files, the increasing data storage capacities of modern audio playback systems and the ability of playback systems to access external audio files from sources such as the internet and the like, there is a general need for audio playback systems having improved ability to acquire, store, maintain and/or play back such audio information.

### BRIEF DESCRIPTION OF DRAWINGS

In drawings which show non-limiting embodiments of the invention:

FIG. 1 schematically depicts an example of a system which may make use of the probabilistic audio networks of this invention;

FIG. 2 depicts the data storage of the FIG. 1 system and a schematic illustration of an example network in accordance with a particular embodiment of the invention;

FIG. 3A is a schematic representation of a data structure that may be used to implement a node of the FIG. 2 network in accordance with a particular embodiment of the invention;

FIG. 3B is a schematic representation of a data structure that may be used to implement a link of the FIG. 2 network in accordance with a particular embodiment of the invention;

FIG. 3C is a schematic representation of a data structure that may be used to implement an entry/exit list for the FIG. 2 network in accordance with a particular embodiment of the invention;

FIG. 4 is an schematic block diagram of a method for adding new nodes to the FIG. 2 network according to a particular embodiment of the invention;

FIG. 5 is a schematic block diagram of a method for operating an audio playback system incorporating the FIG. 2 network according to a particular embodiment of the invention;

FIGS. 6A, 6B and 6C are schematic illustrations of a play history list according to a particular embodiment of the invention;

FIG. 7 is a schematic illustration of a taboo list according to a particular embodiment of the invention;

FIG. 8 is a schematic illustration of a method for selecting a new node for playback using the FIG. 7 taboo list according to a particular embodiment of the invention; and

FIG. 9 is a schematic depiction of a system that may create, maintain and make use of media content networks in accordance with a particular embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Particular aspects of the invention provide methods and apparatus for selecting a playback order of audio (or other media) tracks from a collection of accessible audio tracks. The methods and apparatus may be applied to selecting a playback order of audio tracks from a collection of different types of accessible audio tracks.

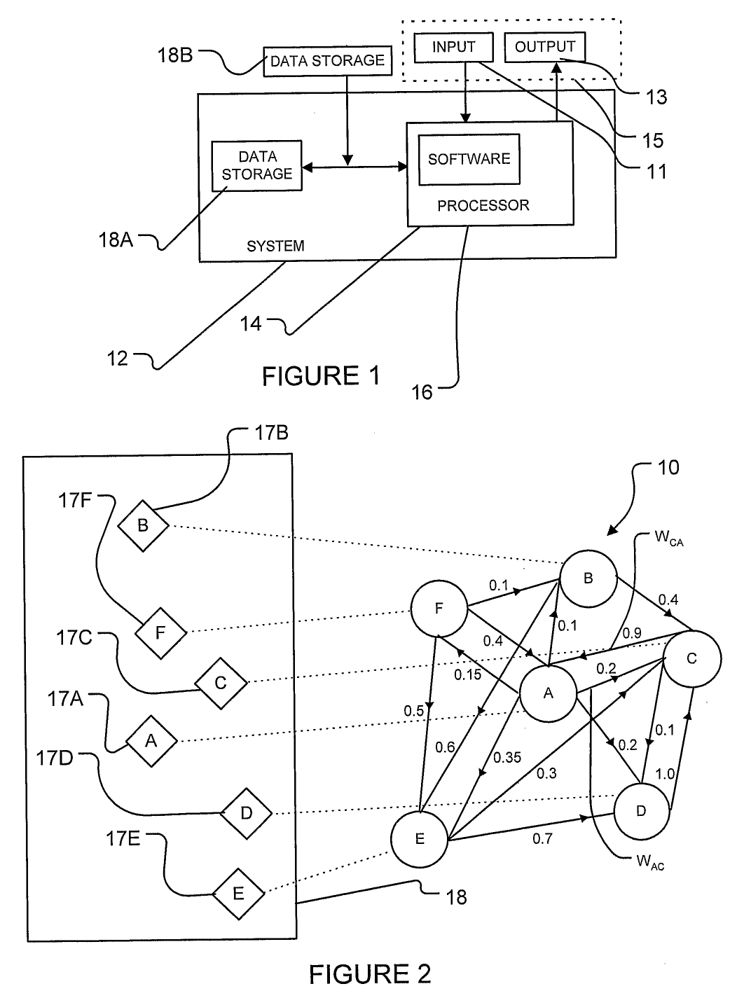

FIG. 1 depicts an example system 12 which may make use of or otherwise incorporate various aspects of the invention. System 12 may be an audio (or other media) playback system. System 12 may comprise a computer, a portable media player, an embedded system, part of a communication network, a stand-alone device or any other system or device which comprises a processor 14 capable of executing program instructions 16 and which comprises, or is otherwise capable of providing access to, internal data storage 18A and/or external data storage 18B (collectively, data storage 18). Data storage 18 may comprise any suitable storage medium, such as an optical disk, magnetic disk, solid state memory, flash memory, a combination thereof or the like.

A user may interact with system 12 via input device 11 and output device 13. Input device 11 may comprise one or more of any suitable input device, such as a mouse, a keyboard, a series of buttons, a rolling input or the like, for example. Similarly, output device 13 may comprise one or more of any suitable output device, such as a flat screen display, an audio output device (e.g. speakers or headphones), a CRT monitor or the like for example. System 12 and/or software 16 may cause input device 11 and output device 13 to work together to provide a user interface 15 (e.g. a graphical and/or text-based user interface). In general, the invention disclosed herein should not be limited by the selection of data storage 18, input device 11 or output device 13. System 12 may comprise other components (not shown), such as amplifiers and the like, which are not germane to the present invention.

System 12 may be a stand-alone unit or may itself be a part of an external communication network (not shown), such as a local area communication network (LAN) or the internet, for example. External data storage 18B may be directly accessible by system 12 or may be accessible through such an external communication network. Software 16 may be executed by data processor 14 and may control how data processor 14 (and any other components of system 12) access data storage 18.

Data storage 18 is schematically depicted in FIG. 2. Data storage 18 may store data items 17A-17F (collectively and individually, data items 17). In some embodiments, data items 17 comprise media content, such as audio content, video content or the like. Data items 17 may also comprise other data related to their respective media content. The related data included in data items 17 may comprise properties of the media content, such as metadata, for example. In some embodiments, data items 17 comprise audio tracks. For ease of explanation, “data item(s)” 17 may be referred to as “audio track(s)” 17 or “track(s)” in the remainder of this description. This nomenclature should be expressly understood not to limit the scope of data items 17 to audio tracks.

In the illustrated example of FIG. 2, data storage 18 is shown, for simplicity, as storing only five audio tracks 17A-17F. In general, the number of audio tracks 17 stored by data storage 18 may be much larger (e.g. 10⁵ or more audio tracks 17) and is only limited by the capacity of data storage 18. As discussed above, data storage 18 need not be local to system 12. One or more of audio tracks 17 may be in external data storage 18B and may be accessible to system 12 via communication network-based music providers and/or communication network-based subscription services. Such communication network-based providers and services may be accessed via a LAN or via the internet, for example. Such network-based providers and services may charge fees for accessing, downloading or otherwise acquiring and/or playing back of their audio tracks 17.

Within the context of data storage 18, audio tracks 17 may be disorganized. By way of non-limiting example, audio tracks 17 may be stored in different directories or “folders”, audio tracks 17 may be stored on different data storage units (e.g. an optical disc drive and a magnetic hard drive), and audio tracks 17 may be stored in local data storage 18A and remote data storage 18B. In accordance with a particular embodiment of the invention shown in FIG. 2, system 12 and/or software 16 creates a network 10 which represents audio items 17 and provides techniques for playing back audio tracks 17.

FIG. 2 depicts an example network 10 which may be created to represent audio tracks 17 in accordance with a particular embodiment of the invention. Network 10 of the illustrated example comprises nodes A . . . F (shown as circles in FIG. 1A). As shown by dashed lines in FIG. 2, each node A . . . F in network 10 represents a corresponding audio track 17A-17F. Any two nodes A . . . F in network 10 may be associated with each other via a directed link (shown in FIG. 2 as non-dashed lines having arrows to indicate their direction). For example, link w_{CA} represents a link exiting node C and entering node A and link w_{AC} represents a link exiting node A and entering node C. Nodes A-F and links w_{AC}, w_{CA} . . . may be implemented by system 12 and/or software 16 as data structures or parts of data structures.

As explained in more detail below, the links exiting a particular node may be assigned link strengths. Such link strengths may be based on similarities between the particular node and the other nodes in network 10. Such link strengths may be normalized such that the sum of the normalized link strengths exiting any given node is unity. In the illustrated embodiment of FIG. 2, the strength of each link is shown in its normalized form, represented by number in the range [0,1] located adjacent to the link. A smaller number represents a relatively low link strength and a larger number represents a relatively high link strength.

Network 10 may be tangibly embodied as a plurality of related data entities which may be maintained and dynamically updated by system 12. Network 10 may be implemented in software or hardware or a combination of software and hardware. In specific embodiments, the data entities of network 10 may take the form of data structures. As described below, network 10 assists system 12 (and users of system 12) to manage audio tracks 17 contained in data storage 18. Users interact with network 10, and network 10 interacts with users, via user interface 15. For ease of explanation, network 10 may be conceptualized as a plurality of nodes A-F and links w_{AC}, w_{CA} . . . discussed herein.

In accordance with a particular embodiment of the invention, if system 12 plays back a particular audio track 17 corresponding to a particular node, then the probability of subsequently playing back a new audio track depends on the normalized link strength assigned to the link exiting the particular node and entering the node which represents the new audio track. For example, if system 12 plays back a particular audio track 17A corresponding to node A, the probability of subsequently playing back a new audio item 17B depends on the normalized link strength assigned to the link wAB exiting node A and entering node B.

Nodes A-F of network 10 have a one-to-one relationship with their corresponding audio tracks 17A-17F. Nodes A-F may be implemented as data structures. In some embodiments, the data structures associated with nodes A-F contain their corresponding audio tracks 17A-17F. Preferably, however, the data structures associated with nodes A-F contain information recognizable to system 12 and/or software 16 about how to access their corresponding audio tracks 17A-17F. By way of non-limiting example, such information may include: a universal remote locator (URL); an internet protocol address; a directory path and filename; a memory address or the like. Information about how to access a particular audio track (e.g. audio track 17A) is referred to herein as a “pointer” to audio track 17A.

The concept of pointers is well understood by software engineers. Pointers may point to audio tracks 17 that reside in internal data storage 18A, to audio tracks 17 that reside in external data storage 18B and/or to audio tracks 17 that reside in part in internal data storage 18A and in part in external data storage 18B. In the case where pointers point to audio data that resides in external data storage 18B, such external data storage may be accessed via the internet or some other communication network.

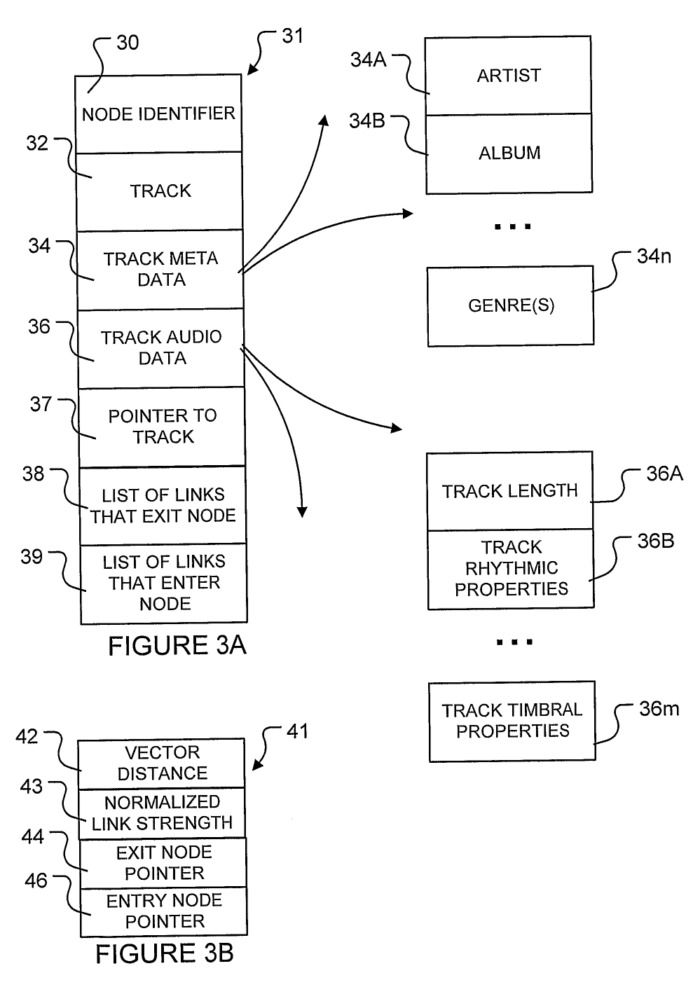

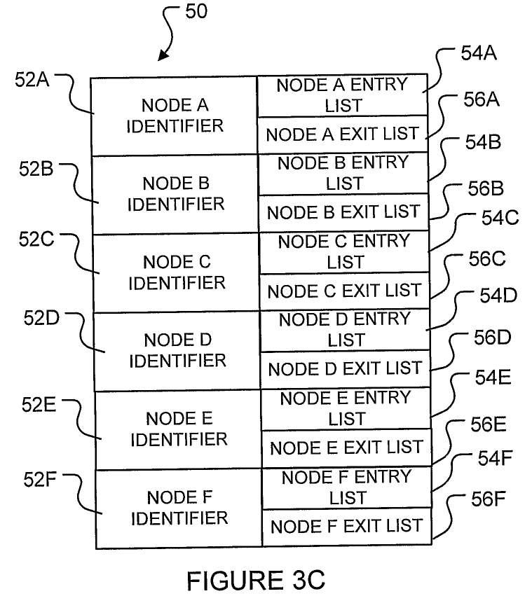

FIG. 3A schematically depicts a data structure 31 which may be used to implement nodes A-F of network 10 according to a particular embodiment of the invention. In the illustrated example of FIG. 3A, data structure 31 comprises:
a node identifier 30 which uniquely identifies the node and its corresponding audio track 17;
a track field 32, which may contain the name of the audio track;
a track metadata field 34;
a track audio data field 36;
a pointer 37 to its corresponding audio track 17;
a list 38 of the links that exit the node; and
a list 39 of links that enter the node.

Track metadata field 34, may itself comprise any number of sub-fields 34A, 34B . . . 34n. In the illustrated example, track metadata sub-field 34A represents the artist(s) that created the corresponding audio track, track metadata sub-field 34B represents the album from which the audio track came and track metadata sub-field 34n represents the genre(s) to which the track belongs. In some embodiments, one or more of these sub-fields 34A, 34B . . . 34n may comprise a vector list or the like having multiple entries. For example, an audio track may have a composer, a writer, and any number of performer(s) and each of these artists may be represented as an entry in a vector list incorporated into artist sub-field 34A. Similarly, an audio track may have multiple associated genres which may be represented as entries in a vector list incorporated into genre sub-field 34n. In some embodiments, one or more of these sub-fields 34A, 34B . . . 34n may themselves comprise sub-fields. For example, the genre(s) sub-field 34n may comprise a primary genre sub-field and one or more secondary genre sub-fields.

The metadata that is associated with an audio track 17 is not limited to the metadata shown in data structure 31. In general, data structure 31 may incorporate any suitable metadata into metadata field 34. Non-limiting examples of metadata include: title of the audio track; alternate titles; dates of writing, publication, recording and/or release of the track; ranking of the track on a “billboard chart” or similar popular music list; user ranking of the track; collaborative filter ranking of the track; information on revision of the track; and information relating to source materials used in the creation of the track.

In data structure 31, track audio data field 36 also comprises a number of sub-fields 36A, 36B . . . 36m. In the illustrated example, audio data sub-field 36A represents the track length, audio data sub-field 36B represents the track rhythmic properties (of which tempo is an example) and audio data sub-field 36m represents the track timbral properties. Audio data sub-fields 36A, 36B . . . 36m may also incorporate vector lists or sub-fields similar to those of metadata sub-fields 34A, 34B . . . 34n. The audio data that is associated with audio track 17 is not limited to the audio data shown in data structure 31. In general, data structure 31 may incorporate any suitable audio data into audio data field 36. Non-limiting examples of audio data include: bit rate of the audio track; encoding format of the audio track; a playback counter associated with the audio track; a last played time stamp relating to the audio track; audio track structural properties (e.g. an audio track may be segmented); and time dependent rhythmic and/or spectral properties. In the embodiments, where data item 17 comprises another type of media content (i.e. other than pure audio content), then sub-fields 36A, 36B . . . 36m may comprise other types of media information.

The data used to populate the fields and sub-fields of data structure 31 may be obtained by, or otherwise provided to, network 10 via user input, via access to a communication network such as the internet, via accessing databases containing music information and/or by using audio analysis software, for example. In some cases, one or more properties of a data item 17 (e.g. metadata) may be associated with the data item 17 prior to the data item being added to network 10, such that system 12 and/or software 16 may obtain the properties when the data item is added (as a node) to network 10 and use these properties to populate the fields and sub-fields of data structure 31. The fields and sub-fields of data structure 31 need not be fully populated.

FIG. 3B schematically depicts a data structure 41 for a link of network 10 in accordance with a particular embodiment of the invention. In FIG. 3B, link W_{AC} data structure 41 comprises: a vector distance field 42 (explained in more detail below); a normalized link strength field 43; a pointer 44 (e.g. node identifier 30) corresponding to the node from which the link exits; and a pointer 46 corresponding to the node to which the link enters. For example, for link W_{AC} (which exits node A and enters node C), exit node pointer 44 points to node A and entry node pointer 46 points to node C. The combination of exit node pointer 44 and entry node pointer 46 uniquely identify link W_{AC}. In other embodiments, link data structure 41 may comprise a separate unique link identifier field.

System 12 and/or software 16 may maintain an entry/exit list which identifies the nodes in network 10 and maintains a list of the links that enter each node and a list of the links that exit from each node. FIG. 3C is a schematic representation of a data structure 50 that may be used to implement an entry/exit list in accordance with a particular embodiment of the invention. Data structure 50 comprises a number of entries, with each entry indexed by a node identifier field 52A-52F which may correspond to the node identifiers 30 of nodes A-F. The entries of data structure 50 also comprise lists 54A-54F of links entering their corresponding nodes A-F and lists 56A-56F of links exiting their corresponding nodes. For example, the field corresponding to node C comprises a node identifier field 52C, a list 54C of links entering node D and a list 56C of links exiting node C.

Data structures 31, 41 and 50 of FIGS. 3A-3C are merely examples of data structures that may be used for nodes, links and entry/exit lists in accordance with particular embodiments of the invention. In other embodiments, data structures representing nodes, links and entry/exit lists may comprise different sets of fields and sub-fields which may or may not be populated.

When new audio tracks 17 become accessible to system 12, new nodes may be added to network 10. When a new node is added to network 10, new links may be created between the newly-added node and one or more existing nodes in network 10. Such newly-created links may enter and/or exit the newly-added node. New links can be manually created (e.g. by a user) and/or automatically created (e.g. by software 16) when a new node is added to network 10 and/or during creation of network 10.

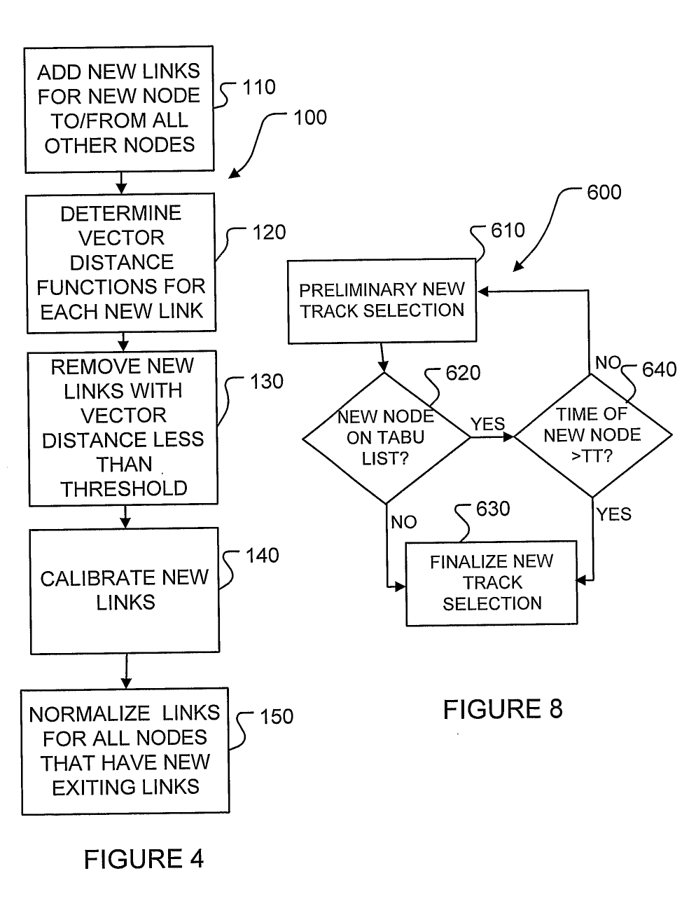

FIG. 4 depicts a method 100 for adding a new node to network 10 and for creating new links in network 10 in accordance with a particular embodiment of the invention. In method 100, when a node is newly-added, links are automatically created in block 110 from the newly-added node to every previously-existing node in network 10 and from every previously-existing node in network 10 to the newly-added node.

After creating these new links in block 110, a link strength may be determined for each of the newly-created links. The strength of each newly-created link may be manually determined (e.g. by user input) or automatically determined (e.g. by software 16) and may be based on the similarity between the audio tracks 17 represented by the nodes between which the link extends. The similarity between two audio tracks 17 may be derived from a comparison of the properties associated with the audio tracks. Some of the properties of an audio track 17 may populate the fields of the node data structure which represents the audio track 17 in network 10. For example, metadata field 34 and audio data field 36 of node data structure 31 may be populated by the properties of a corresponding audio track 17. For ease of explanation, the properties of an audio track 17 that populate the fields of the node data structure 31 representing the audio track 17 may be referred to herein as the “properties of the node” and/or the “properties associated with the node”.

The similarity between the properties of a pair of nodes or a pair of audio tracks 17 may be based on metadata field 34. For example:
two audio tracks 17 that have the same artist field 34A may have greater similarity than two audio tracks 17 with different artist fields 34A;
the similarity of two audio tracks 17 that have different artist fields 34A may depend on the similarity of the artists themselves. The similarity of a pair of artists may be ascertained by human expertise (e.g. the opinions of musicologists) which may be provided to system 12 and/or software 16. The similarity of a pair of artists may additionally or alternatively be ascertained by comparing known information about the artists (e.g. the artists lived at the same or different times, the artists come from the same or different countries and the artists either did or did not collaborate on one or more tracks). Such information may also be provided to system 12 and/or software 16. The similarity of a pair of artists may additionally or alternatively be ascertained using metadata that may be obtained by system 12 and/or software 16 by web-crawling or using collaborative filtering techniques. For example, a web-crawler or a collaborative filter may be able to determine the frequency of occurrence of the two artists on a common playlist. Yet another additional or alternative technique for determining the similarity between a pair of artists involves analyzing audio data of the tracks created by the artists and predicting a similarity between the artists on the basis of the similarity between the audio properties of their tracks;
two audio tracks 17 that have the same album field 34B may have greater similarity than two audio tracks 17 with different album fields 34B;
the similarity of two audio tracks 17 that have different album fields 34B may depend on the similarity of the albums themselves. The similarity of a pair of albums may be ascertained using techniques similar to those used for determining the similarity of a pair of artists. Such techniques may involve supplying system 12 and/or software 16 with human expertise (e.g. the opinions of musicologists) and/or with known information about the albums (e.g. the albums were created by the same artists or by the same record label). The similarity of a pair of albums may additionally or alternatively be ascertained using metadata that may be obtained by system 12 and/or software 16 by web-crawling or using collaborative filtering techniques. For example, a web-crawler or a collaborative filter may be able to determine the frequency of occurrence of tracks from both albums on a common playlist. Yet another additional or alternative technique for determining the similarity between a pair of albums involves analyzing audio data of the tracks on both albums and predicting a similarity between the albums on the basis of the similarity between the audio properties of their tracks;
two audio tracks 17 that have the same genre 34n may have greater similarity than two audio tracks 17 with different genres 34n; and
the similarity of two audio tracks 17 that have different genres 34n may depend on the similarity of the genres themselves. The similarity of two genres may also be ascertained using similar techniques. Such techniques may involve supplying system 12 and/or software 16 with human expertise (e.g. the opinions of musicologists) and/or with known information about the genres (e.g. some tracks or artists are often classified in both genres). The similarity of a pair of genres may additionally or alternatively be ascertained using metadata that may be obtained by system 12 and/or software 16 by web-crawling or using collaborative filtering techniques. For example, a web-crawler or a collaborative filter may be able to determine the frequency of occurrence of tracks having both genres on a common playlist. Yet another alternative or additional technique for determining the similarity between a pair of genres involves analyzing audio data of one or more tracks classified as being in each genre and predicting a similarity between the genres on the basis of the similarity between the audio properties of the analyzed tracks.

The similarity between the properties of a pair of nodes or a pair of audio tracks 17 may be based on audio data field 36. For example:
the similarity between two audio tracks 17 may depend on how they sound to a listener (i.e. subjectively) as may be indicated by user input or as may otherwise be provided to system 12 and/or software 16; and
the similarity of two audio tracks 17 may depend on the similarity of audio data sub-fields, such as rhythmic properties 36B, timbral properties 36n and length 36A.

In the particular embodiment of method 100, the strengths of the newly-created links are automatically determined on the basis of the properties of the newly-added node and the properties of the previously-existing nodes in network 10. This automatic determination of link strength may be based on the correlation (i.e. similarity) between the properties of the newly-added node and the properties of the existing nodes.

In the embodiment of FIG. 4, block 120 involves determining vector distances d between the properties of the newly-added node and the properties of the existing nodes and assigning these vector distances d to the newly-created links (i.e. the links between the newly-added node and the previously-existing nodes). The newly-added node and the previously-existing nodes of network 10 may each comprise a set of up to k properties. The properties of two arbitrary nodes X and Y may be respectively represented by the vectors x=(x₁, x₂, . . . , xₖ), y=(y₁, y₂, . . . , yₖ)

In accordance with one particular embodiment, the vector distance function d(x,y) for two arbitrary nodes X, Y is given by the Euclidean norm:

$$d ( x , y ) := \sqrt{{\sum }_{i = 1}^{k} {( {x}_{i} - {y}_{i} )}^{2}}$$

In other embodiments, the vector distance function d(x,y) has other forms. For example, the vector distance function d(x,y) may be given by the cosine distance function:

$$d ( x , y ) := \frac{{\sum }_{i = 1}^{k} {x}_{i} {y}_{i}}{( ‖ x ‖ ) ( ‖ y ‖ )}$$

where ∥x∥=(x₁x₁+x₂x₂+ . . . +xₖyₖ)^{1/2}. The cosine distance function outputs a result in the range of [−1,1], where an output of 1 corresponds to identical vectors.

Some of the properties (e.g. x₁, x₂, x₃ . . . xₖ and y₁, y₂ . . . yₖ) associated with nodes X and Y may be coded into a numerical format to facilitate the calculation of a vector distance function d(x,y). In some cases, a particular property xᵢ, yᵢ may already exist in numerical format. Such numerical properties may include timbral properties 36m, rhythmic properties 36B and track length 36A. Inherently, numerical properties may be scaled or normalized before being used in the calculation of a vector distance d. In other cases, where a particular property xⱼ, yⱼ is not inherently numeric, system 12 and/or software 16 may be provided with a mapping function Mⱼ(x) which maps the j^{th} property into an n-dimensional numerical space. System 12 and/or software 16 may be provided with a mapping function Mⱼ(x) for each non-numeric property. Properties which are not inherently numeric include artist 34A, album 34B and genre 34n. The mapping functions Mⱼ(x) may be based on empirical formulae developed by musicians, musicologists or the like. The mapping functions Mⱼ(x) may take advantage of available music databases and similar resources, which may be local to system 12 and/or accessible to system 12 over a communication network such as the internet.

In some embodiments, particular properties of the newly-added node and the previously-existing node may be given increased weight when determining the vector distance function d(x, y). In such cases, the weighted Euclidean norm vector distance function may be given by:

$$d ( x , y ) := \sqrt{{\sum }_{i = 1}^{k} {{a}_{i} ( {x}_{i} - {y}_{i} )}^{2}}$$

where aᵢ represents a weighting coefficient assigned to the i^{th} property. As an example, it may be desirable to give extra weight to similarities in the artist field 34A between a newly-added node and a previously-existing node. The artist field 34A may be property x₃ in the newly-added node and property y₃ in the previously-existing node. In such a case, the weighting coefficient a₃ may have a relatively high value in comparison to other weighting coefficients. In some embodiments, the weighting coefficients aᵢ may additionally or alternatively depend on an average value of the i^{th} property.

As a part of block 120, the output of the vector distance function d(x,y) may be linearly scaled and/or linearly offset to provide a suitable vector distance range. Those skilled in the art will appreciate that there are many other distance functions and similar functions which can be used to compute a correlation/similarity between a pair of vectors.

Another technique for determining the similarity or correlation between two vectors involves using classifier models of machine learning. For example, classifier may be trained to map inherent properties of an audio track 17 (e.g. spectral properties, tempo, timbral properties and track length) into a metadata property, such as genre for example. The classifier may be trained using a set of training vectors. Preferably, the training vectors are developed from actual audio tracks. Each of the vectors in the training set is provided with the inherent properties being considered (e.g. spectral properties, tempo, timbral properties and track length) and a label corresponding to the metadata property. For example, where the metadata property is genre, the training set may include training vectors having labels, such as pop, rock, rap, classical, jazz, blues, or the like. Using the training set, the classifier develops a set of parameters that map the inherent properties of an audio track 17 (e.g. spectral properties, tempo, timbral properties and track length) into one of the labels of the training set. The classifier may then be used to predict a metadata property of arbitrary audio tracks 17 on the basis of the inherent properties of the audio tracks. In the example described above, the classifier may be provided with a vector corresponding to the inherent properties of an arbitrary audio track 17 (e.g. spectral properties, tempo, timbral properties and track length) and will predict the genre of the audio track.

To assess the similarity between the properties of two nodes, a classifier may be trained using a set of training vectors, where each vector in the training set is based on the properties of a pair of nodes. For example, as discussed above, the properties of a pair of nodes t, Y may be represented by a pair of vectors x=(x₁, x₂, . . . , xₖ), y=(y₁, y₂, . . . , yₖ). A vector in the training set may then be represented by concatenating the vectors x and y to form a training vector r, having the form r=(x₁, x₂, . . . , xₖ, y₁, y₂, . . . , yₖ). The labels of the training set may be a set of predetermined discrete similarity levels. Using this training set, the classifier develops a set of parameters that map a concatenated vector having the form (x₁, x₂, . . . , xₖ, y₁, y₂, . . . , yₖ) into one of the discrete similarity levels corresponding to the labels of the training set. The classifier may then be used to predict the similarity of a pair of arbitrary audio tracks 17 on the basis of the vectors x=(x₁, x₂, . . . , xₖ), y=(y₁, y₂, . . . , yₖ) representing the properties of the audio tracks. In the example described above, the classifier may be provided with a concatenated vector of the form (x₁, x₂, . . . , xₖ, y₁, y₂, yₖ) corresponding to the properties the pair of arbitrary audio tracks 17 and will predict the similarity of the pair of audio tracks to one of the discrete similarity levels used in the training.

After creating links between the newly-added node and the previously-existing nodes in block 110 and determining the vector distances d assigned to each of the newly-created links in block 120, newly-created links having vector distances d less than a threshold θ may be removed (or otherwise excluded (e.g. by setting their vector distance d=0)) from network 10 in block 130. Threshold θ may be a user-configurable parameter or may be set as a predetermined threshold in network 10. Threshold θ need not be a constant value. Threshold θ may be a function of the particular vector distance function d(x,y) used in block 120 to determine the similarity of the newly-added node to the previously-existing nodes and/or one or more of the individual properties (e.g. x₁, x₂, x₃ . . . xₖ and y₁, y₂, y₃ . . . yₖ) used to determine the vector distance d in block 120.

In method 100, block 140 involves applying a calibration function ƒ(d) to the vector distances d of the remaining newly-added links. Preferably, the calibration function ƒ(d) is a non-linear function which may be used to de-emphasize newly-created links having statistically-outlying vector distances d and/or to improve the dynamic range of the vector distances d for the newly-created links. For example, if there are ten newly-created links after the block 130 thresholding operation and nine of the newly-created links have vector distances d in a range of [0.5, 0.65] and one of the newly-created links has a vector distance d of 0.95, then it may be useful to emphasize the range of vector distances between [0.5, 0.65] and to de-emphasize vector distances in a vicinity of 0.95, so as to provide more dynamic range for the vector distances d in the range [0.5, 0.65].

In accordance with one particular example, the calibration function ƒ(d) is given by:

f(d):=a·2^{b·d}·d^{c}

where d=d(x,y) is the vector distance function between nodes X and Y and a, b, c are numerical calibration parameters. Parameters a, b, c may be user-configurable parameters or may be pre-configured parameters. Parameters a, b, c need not be constant and may be functions of the particular vector distance function d(x,y) used to determine the vector distances d in block 120. Where the parameters a, b, c depend on certain properties of the nodes, the block 140 calibration may be used to provide weight to certain properties of the nodes.

Additional calibration mechanisms may be provided as a part of block 140 (or elsewhere in method 100) for situations where a newly-added node has no links exiting from the node (i.e. all links exiting from the newly-added node were removed in the block 130 thresholding process) or a newly-added node has no links entering the node (i.e. all links entering the newly-added node were removed in the block 130 thresholding process). For example, for a newly-added node that has no exiting links, an additional calibration mechanism may comprise adding links (with some nominal value δ in the place of vector distance d) exiting from the newly-added node and entering all of the other nodes in network 10 (or some subset of the other nodes in network 10, such as the n nodes determined to be most similar to the newly-added node prior to the block 130 thresholding process). Similarly, for a newly-added node that has no entering links, an additional calibration mechanism may comprise adding links (with some nominal value E in the place of vector distance d) exiting from every other node in network 10 (or some subset of the other nodes in network 10, such as the n nodes determined to be most similar to the newly-added node prior to the block 130 thresholding process) and entering the newly-added node.

At the conclusion of the block 140 calibration process, the calibrated vector distances d (or the nominal values δ, ε) for each link may be retained in field 42 of the link data structure 41. Block 150 involves normalizing the vector distances d to obtain normalized link strengths. The block 150 link normalization process occurs for all nodes that have new exiting links or a change in their exiting links (i.e. as a result of blocks 110, 120, 130 and 140). Normalizing link strengths may be accomplished, for each node X, by dividing the calibrated vector distance d (or the nominal values δ, ε) of each individual link exiting from node X by the sum of the calibrated vector distances d (or the nominal values δ, ε) of all links exiting from node X. This may be accomplished by dividing the individual vector distance fields 42 of the link data structures 41 exiting node X by the sum of the vector distance fields 42 of the link data structures 41 exiting node X.

In alternative embodiments, where data structure 41 does not include vector distance field 42, the vector distances d may be recalculated for all of the links exiting from a node which receives a new exiting link as a result of blocks 110-140.

As a part of the block 150 normalization, the previously-existing links exiting from each node being normalized may have their link strengths re-normalized (i.e. because of the addition of new links). The re-normalized link strength of these previously-existing links may be subjected to a new threshold test. If the re-normalized link strength of a previously-existing link has decreased (e.g. because of the presence of a new link) and the strength of the previously-existing link is now below some re-normalization threshold λ, then the previously-existing link may be discarded and the block 150 normalization procedure may be repeated for that node. The re-normalization threshold λ may be a user configurable or a predefined parameter and may be a global parameter or a parameter that is specific to each node. The re-normalization threshold λ need not be constant and may be a function of the total number of links exiting a particular node. For example, the re-normalization threshold λ may be relatively low where the number of links exiting a particular node is relatively high and the re-normalization threshold λ may be relatively high where the number of links exiting a particular node is relatively low.

After normalization in block 150, the sum of the normalized link strengths for all of the links exiting from a particular node is unity. The normalized link strength may be retained in field 43 of link data structure 41.

For ease of description, method 100 is described for the case of adding a single new node to an existing network 10. Those skilled in the art will appreciate that adding multiple new nodes (or even new networks incorporating a plurality of nodes and links) may involve an extension of method 100. Such an extension of method 100 may involve repetitive application of method 100, but may additionally or alternatively involve some economization of method 100 to account for the addition of multiple new nodes. For example, some of the method 100 procedures may be implemented in parallel for some of all of the newly-added nodes.

The normalized link strengths determined in method 100 may be used as probabilities for transitions from one node in network 10 to another node in network 10 via a link. A transition between nodes of network 10 via a link may correspond with playback of an audio track 17 represented by the first node followed by playback of an audio track 17 represented by the second node. Accordingly, the normalized link strengths determined in method 100 may be used by system 12 and/or software 16 to determine the track playback order. Because the normalized strengths of links connecting nodes having similar properties will tend to be higher than the normalized strengths of links connecting nodes having dissimilar properties, the probability of a transition between nodes having similar properties is greater than the probability of a transition between nodes having dissimilar properties. Accordingly, successive playback of audio tracks 17 that are similar to one another is more likely than successive playback of audio tracks 17 that are dissimilar to one another.

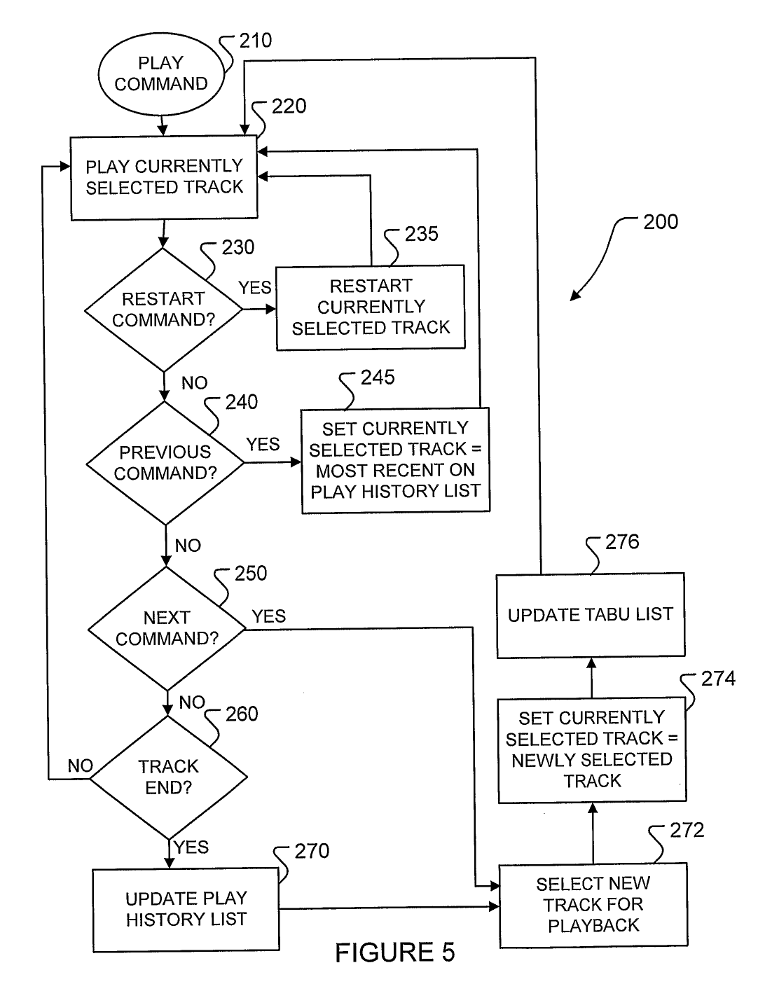

FIG. 5 shows a method 200 for operation of an audio playback system 12 incorporating network 10 (i.e. playing back the audio tracks 17 associated with the nodes of network 10). A user may interact with system 12 by activating a ‘play’ command in block 210. A user may activate the play command using any suitable hardware or software input 11. For example, a user may press a hardware button on input device 11 or a software button implemented on a software-based graphical (or textual) user interface 15 running on system 12.

When the block 210 play command is activated, the ‘currently-selected track’ is played back in block 220. Selection of the currently-selected track is explained in more detail below. When the play command is activated in block 210 for the first time (e.g. after system 12 has been powered down or after a predetermined amount of time), then the block 220 playback may involve playing back the track associated with a predetermined node (i.e. setting the track associated with a predetermined node to be the currently-selected track), playing back the track associated with a random node (i.e. setting the track associated with a random node to be the currently-selected track) or playing back the track associated with a user-selected node (i.e. where the user selects the track associated with a particular node to be the currently-selected track before or after activating the block 210 play command).

In the absence of additional user input, method 200 proceeds through blocks 230, 240 and 250 to block 260. If it is determined (in block 260) that playback of the currently-selected track has not ended (block 260 NO output), then method 200 loops back to block 220 and continues playing the currently-selected track. If it is determined (in block 260) that playback of the currently-selected track has ended (block 260 YES output), then method 200 proceeds to block 270, where it updates a play history list as explained below.

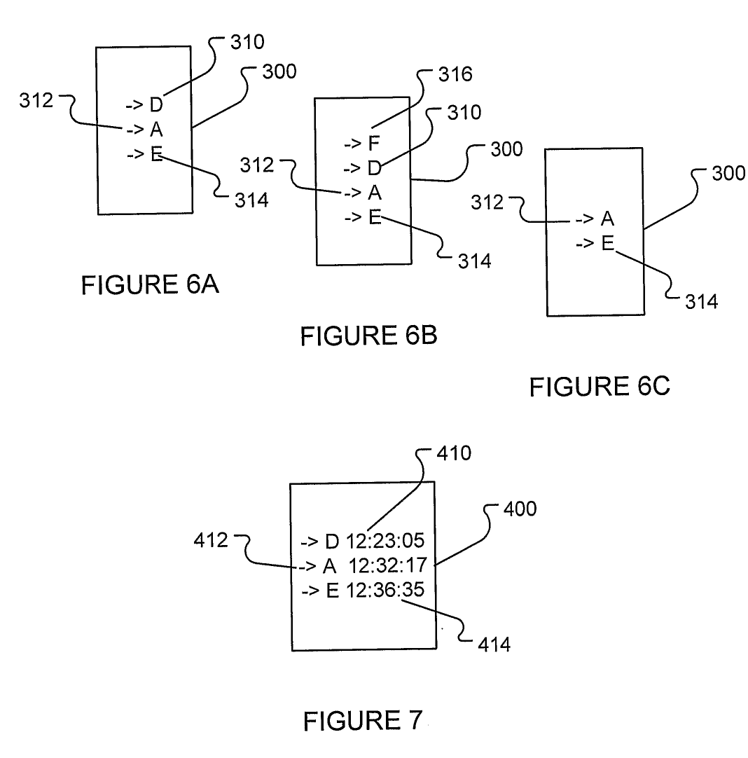

Network 10 may maintain a play history list. FIG. 6A schematically depicts an example play history list 300. In the illustrated embodiment, play history list 300 comprises one or more pointers 310, 312, 314 to one or more nodes D, A, E whose associated tracks have recently been played back. Preferably, play history list 300 is an ordered list (i.e. pointers to nodes associated with more recently played tracks are closer to the top of the list and the pointers to nodes associated with tracks played a longer time ago are closer to the bottom of the list). In the illustrated example of play history list 300 in FIG. 6A, pointer 310 (corresponding to node D) is at the top of the list, indicating that the track 17D has been more recently played back than tracks 17A and 17E. Similarly, pointer 312 (corresponding to node A) is higher in list 300 than pointer 314 (corresponding to node E) indicating that track 17A has been played back more recently than track 17E.

In block 270, play history list 300 is updated to reflect the fact that playback of the currently-selected track has just ended (block 260 NO output). FIG. 6B depicts a schematic example of how play history list 300 changes after it has been updated in block 270 to reflect the fact that playback of the track 17F has just ended. As shown in FIG. 6B, a new pointer 316 to node F has been added at the top of play history list 300 and pointers 310, 312, 314 have moved down play history list 300.

In block 272, a new track is selected for playback. Preferably, the block 272 selection of a new track for playback involves a transition from the node associated with the currently-selected track to a new node via a link that exits from the node associated with the currently-selected track and enters the new node. For example, in network 10 of FIG. 2, if the currently-selected track is track 17F (corresponding to node F), then the block 272 selection of a new track for playback involves selection between tracks 17A, 17B and 17E (i.e. network 10 has links from node F to nodes A, B and E but has no links from node F to node C or node D).

In accordance with one particular embodiment, if X denotes the node associated with the currently-selected track (i.e. whose playback has just ended), Y denotes another node in the network and there is a link exiting node X and entering node Y, then the track associated with node Y is selected to be the next track in block 272 with probability pXY, where pXY is the normalized link strength of the link from node X to node Y. Returning to the previous example of network 10 (FIG. 2) where the currently-selected track (i.e. whose playback has just ended) is track 17F, the probabilities that the tracks 17A, 17B and 17E are selected as the next track in block 272 are given by: pFA=0.4, pFB=0.1 and pFE=0.5. For this reason, network 10 may be referred to as a “probabilistic audio network”.

The block 272 track selection may be performed via a number of methods. In one particular embodiment, the normalized link strengths of the links exiting the node associated with the currently-selected track are assigned concatenating, non-overlapping domains in the range (0,1] and system 12 and/or software 16 generate a pseudo-random number in the range (0,1]. This pseudo-random number is used to select one of the links exiting from the node associated with the currently-selected track. Returning to the previous example of network 10 (FIG. 2) where track 17F is the currently-selected track (i.e. whose playback has just ended), the link w_{FA} may be assigned the range (0, 0.4], the link w_{FB} may be assigned the range (0.4, 0.5] and the link w_{FE} may be assigned the range (0.5, 1.0]. A pseudo-random number generated in the range (0, 1] may then determine one of the links w_{FA}, w_{FB} and w_{FE} (and a corresponding one of nodes A, B and E) with the probabilities pFA=0.4, pFB=0.1 and pFE=0.5. Techniques for generating pseudo-random numbers are well known to those skilled in the art.

After selection of the new node for playback in block 272, method 200 proceeds to block 274, where the currently-selected track is updated to be the newly-selected track (i.e. the track selected in block 272). Method 200 then proceeds through block 276 (explained in more detail below) to block 220, where it begins to playback the new currently-selected track.

During playback of the currently-selected track, a user may interact with system 12 by activating the ‘next’ command. As with the play command, a user may activate the next command using any suitable hardware or software input. In the illustrated embodiment of method 200, activation of the next command is detected in block 250. If the user does not activate the next command (block 250 NO output), then, in the absence of any other user input, method 200 loops through block 260 back to block 220, where it continues to play the currently-selected track. When the next command is activated (block 250 YES output), playback of the currently-selected track ends and method 200 proceeds through blocks 272, 274, 276 (as described above) to select and begin to play a new track. In method 200, block 270 is bypassed when a user activates the next command. In other embodiments, the play history list is updated when a user activates the next command.

During playback of the currently-selected track, a user may also interact with system 12 by activating a ‘restart’ command. As with the other user commands, a user may activate the restart command using any suitable hardware or software input. In method 200, activation of the restart command is detected in block 230. If the user does not activate the restart command (block 230 NO output), then, in the absence of other user input, method 200 loops back through blocks 240, 250 and 260 to block 220, where it continues to play the currently-selected track. If the restart command is activated (block 260 YES output), then playback of the currently-selected track is restarted in block 235 before proceeding back to block 220.

A user may also interact with system 12 by activating the ‘previous’ command. As with the other user commands, a user may activate the previous command using any suitable hardware or software input. In method 200, activation of the previous command is detected in block 240. If the user does not activate the previous command (block 240 NO output), then, in the absence of other user input, method 200 loops back through blocks 250 and 260 to block 220, where it continues to play the currently-selected track. If the previous command is activated (block 240 YES output), then playback of the currently-selected track ends and the currently-selected track is replaced (in block 245) with the track associated with the node corresponding to the most recently added pointer on the play history list. For example, if the previous command is activated while the play history list is play history list 300 of FIG. 6A, then block 245 involves setting the currently-selected track to be track 17D (i.e. pointer 310).

Block 245 also involves removing the pointer to the node associated with the most recently played back track from the play history list. FIG. 6C shows play history list 300 after block 245. It can be seen from comparing FIGS. 4A and 4C, that pointer 310 corresponding to node D is removed from play history list 300 during block 245. At the conclusion of block 245, method 200 loops back to block 220, where it starts to playback the track selected from the play history list.

In some embodiments, selection of the new node for playback in block 272 involves the use of a taboo mechanism which helps to prevent repetition in playback. In accordance with one particular embodiment, before a track 17 is about to start being played back, a taboo list is updated with information about the track 17 and/or its associated node. In method 200, the taboo list is updated in block 276 (i.e. after the newly-selected track is updated to be the currently-selected track in block 274 and before playback of the new currently-selected track commences in block 220).

FIG. 7 illustrates a taboo list 400 according to a particular embodiment of the invention. In the illustrated embodiment, taboo list 400 comprises one or more data elements 410, 412, 414, with each data element 410, 412, 414 comprising a playback time and a pointer to a corresponding node. In taboo list 400, data elements 410, 412, 414 respectively include pointers to nodes D, A, E. In the illustrated embodiment, the playback times included in data elements 410, 412, 414 are shown as clock-based times. The clock-based times of data elements 410, 412, 414 may indicate the times that the tracks associated with nodes D, A, E commenced playback and/or the times that the tracks associated with nodes D, A, E concluded playback. The use of clock-based times in taboo list 400 is not necessary. In some embodiments, the playback times included in data elements 410, 412, 414 may correspond to counters associated with discrete intervals. Such discrete intervals may be temporal intervals or they may represent the intervals between repetitive events. Intervals between repetitive events need not be temporally constant. Non-limiting examples of repetitive events that may form the basis of such discrete intervals include: timer events or interrupts based on a clock signal available to processor 14 (FIG. 1); reaching the end of a track (i.e. block 260 YES output of FIG. 5); and selecting a new node for playback (i.e. block 272 of FIG. 5).

FIG. 8 shows a method 600 for implementing the block 272 selection of a new track for playback when using a taboo list according to a particular embodiment of the invention. Method 600 starts in block 610, where a preliminary selection of a new track is made. The block 610 preliminary selection may be substantially the same as the block 272 selection of a new track described above. That is, the probability of selection a particular new track may depend on the normalized link strength of the link from the node associated with the currently-selected track to the node associated with the particular new track. Block 620 involves checking whether the node associated with the preliminary new track selection is on the taboo list. If the node associated with the preliminary new track selection is not on the taboo list (block 620 NO output), then the preliminary new track selection is finalized as the new track in block 630.

If, on the other hand, the preliminary new track selection is on the taboo list (block 620 YES output), then method 600 proceeds to block 640, where the difference between the current time and the playback time of the preliminary selected track (i.e. the playback time contained in the taboo list for the node associated with the preliminary selected track) is compared to a taboo threshold time TT. If the difference between the current time and the playback time of the preliminary selected track is greater than the taboo threshold time TT (block 640 YES output), then method 600 proceeds to block 630 where the preliminary new track selection is finalized as the new track. If the difference between the current time and the playback time of the preliminary selected track is less than or equal to the taboo threshold time TT, then the preliminary new track is rejected and method 600 proceeds to block 610, where a new preliminary track is selected and method 600 repeats itself.

The taboo threshold time TT may be a user-configurable parameter or may be a parameter that is automatically defined by software 16. The taboo threshold time TT need not be constant and may depend on many factors, such as the number of nodes in network 10 for example. In cases where the playback times of the data elements in taboo list 400 correspond to discrete intervals other than clock-based times, then the taboo threshold time TT need not be a clock-based time and may be a threshold number of discrete intervals.

Whenever a new data element is added to the taboo list in block 276, all data elements whose playback times are further away from the current time than the taboo threshold time TT (i.e. all data elements for which current time-playback time>TT) may be removed from the taboo list. This avoids having the taboo list grow indefinitely. If a taboo list mechanism is used, the taboo list may remain unaffected by activation of the previous command (block 240 of method 200) discussed above.

In may be possible, in some circumstances, that all of the nodes of network 10 are on the taboo list and the differences between the current time and the taboo list playback times for all of the nodes are less than the taboo threshold time TT. In method 600, a flag may be set to indicate this condition. In response to such a flag, method 600 may involve releasing a number n of nodes (preferably, the nodes corresponding to the oldest playback times) from the taboo list. Those skilled in the art will appreciate that there are other ways to overcome this condition. For example, all of the nodes may be released from the taboo list or the taboo threshold time TT may be reduced.

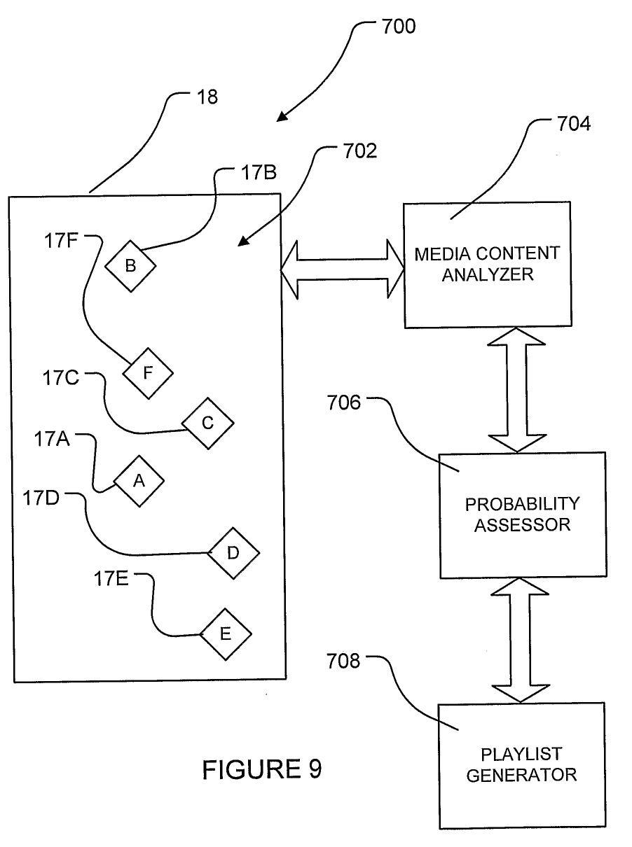

FIG. 9 is a schematic depiction showing some other aspects of a media playback system 700 capable of creating and using networks of the type described above. System 700 comprises data storage 18 for holding a set 702 of media tracks 17. System 700 comprises a media content analyzer 704 for analyzing the media tracks 17 and determining, for each track 17, one or more of following properties: temporal length of the media track; one or more rhythmic properties of the media track; one or more timbral properties of the media track; one or more spectral properties of the media track; a bit rate of the media track; an encoding format of the media track; a playback counter associated with the media track; and a last played time stamp associated with the media track; one or more artists involved in creating the media track; an album on which the media track was released; one or more genres into which the media track may be categorized; a title of the media track; one or more dates associated with the media track; one or more rankings of the media track on one or more corresponding music lists; and membership of the media track on one or more music lists. In some embodiments, media content analyzer determines two or more of the above-listed properties for each track 17. In other embodiments, media content analyzer determines three or more of the above-listed properties for each track 17. In other embodiments, media content analyzer determines four or more of the above-listed properties for each track 17. In other embodiments, media content analyzer determines five or more of the above-listed properties for each track 17. Additionally or alternatively, media content analyzer 704 can receive some of the properties mentioned above from one or more external sources (not shown), such as via user input, from on line databases, from on-line service providers or the like.

System 700 also comprises a probability assessor 706 for determining a probability of a transition from each media track 17 to one or more of the other media tracks 17 in set 702 based, at least in part, on the properties determined by media content analyzer 704. Probability assessor 706 may use vector distance functions as described above to assess probabilities and assign them to links of network 10 as described above. Probability assessor 706 may also receive input from external sources. System 700 also comprises a playlist generator 708 for selecting a sequence of media tracks 17 for playback based at least in part on the probabilities determined by probability assessor 706.

The probabilistic audio networks described above may be used in a variety of different kinds of audio playback systems/devices and a variety of different environments. Non-limiting examples of suitable systems/devices and environments include:
portable devices, such as portable digital audio players, cell phones, PDAs, portable CD players or portable DVD players;
in-car audio systems;
in-home entertainment systems such as DVD players, CD players, or hard disk based systems;
commercial entertainment systems (such as can be found in restaurants, shopping malls, etc.);
desktop or portable computer systems;
electronic music stores which are accessed online; and
browsing and search stations in traditional music stores.
   The probabilistic networks described above may be implemented as part of the firmware on a hardware device, as additional software which can be loaded and executed on a hardware device, and/or as a combination of hardware and software.

Probabilistic audio networks of the type described above may be created manually, automatically, or semi-automatically to reflect the preferences of specific users. Audio networks of the type described above (i.e. including a plurality of links and nodes) may be packaged and sold as pre-prepared audio networks. Such pre-prepared audio networks may be added to a user's existing network (in accordance with the methods of adding nodes discussed above) or may be installed as stand-alone networks. Such pre-prepared audio networks may correspond to, and be marketed as, the preferences of celebrities or other well-known persons, such as pop stars, actors, TV personalities, sports stars, etc. Such pre-prepared audio networks may also be designed for a specific purpose (i.e. playback in a bar, store or shopping center). Such pre-prepared networks may be commercially distributed via the internet or on storage media, such as CDs or DVDs, for example.

Certain implementations of the invention comprise computer processors which execute software instructions which cause the processors to perform a method of the invention. For example, one or more processors in a dual modulation display system may implement data processing steps in the methods described herein by executing software instructions retrieved from a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. Where specified, the program product may also comprise transmission-type media such as digital or analog communication links. The instructions may be present on the program product in encrypted and/or compressed formats.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
Many of the methods described above involve procedural blocks which may be executed in different orders than those depicted in the illustrated embodiments. For example, those skilled in the art will appreciate that in method 200 of FIG. 5, block 230 may be performed after block 240 or after block 250. Similarly, those skilled in the art will appreciate that updating the taboo list in block 276 may occur just after playback of a new currently-selected track is commenced, rather than just before playback of a new currently-selected track is commenced. There may be similar reordering of other procedural blocks of method 200 and/or the procedural blocks of other methods described herein without altering the scope of the invention.
The operational method of FIG. 5 represents only one operational mode of audio playback system 12. Audio playback systems 12 in accordance with the invention may have different operational modes. For example, they may be configured to playback in a sequential playback mode or in a random playback mode known to those skilled in the art. In addition, audio playback systems 12 according to the invention may have one or more non-playback operational modes. Such non-playback operational modes may comprise navigation modes (i.e. for selecting a particular node to playback), content control modes (i.e. for adding and/or removing nodes from network 10), user input modes (i.e. for manually inputting link strengths, properties of nodes and/or other user-configurable aspects of network 10), configuration nodes (i.e. for configuring the system) and the like. Such non-playback operational modes may involve a graphical or textual user interface which may be implemented by software 16 and which may be controlled by the user.
Those skilled in the art will appreciate that techniques to those described above could be used for a variety of media content, such as video content, static image (e.g. photographic) content or the like.
The block 150 normalization procedure of method 100 is not strictly necessary. System 12 may store the calibrated vector distances d and the normalization procedure may actually be performed when determining the probability of moving from one node to an adjacent node.
In some embodiments, a field or sub-field of data structure 31 (such as genre(s) sub-field 34n) comprises a list of the genre classifications considered by system 12 and/or software 16 and a normalized weighting factor in the range [0,1] which assigns a weight to each genre represented by the audio track.
   Accordingly, the scope of the invention is to be construed in accordance with the substance defined by the following claims.

1. A method for selecting media tracks for playback from among a set of accessible media tracks, the method comprising:
providing a set of accessible media tracks and a current track from among the set of accessible media tracks;
establishing, for each individual media track in the set of accessible media tracks, one or more selection probabilities corresponding to the individual media track, each of the one or more selection probabilities indicating a probability that an associated potentially subsequent track is selected as a subsequent track when the individual media track is the current track; and
selecting a first subsequent track in accordance with the one or more selection probabilities corresponding to the current track.

2. A method according to claim 1 wherein the one or more selection probabilities corresponding to the current track comprise at least three selection probabilities that are different from one another.

3. A method according to claim 1 wherein, for each individual track in the set of accessible media tracks, the one or more selection probabilities corresponding the individual track comprise at least three selection probabilities that are different from one another.

4. A method according to claim 3 wherein, for each individual track in the set of accessible tracks, the one or more selection probabilities corresponding to the individual media track depend, at least in part, on one or more properties of the individual media track.

5. A method according to claim 4 wherein each of the one or more selection probabilities corresponding to the current track depends on a relative similarity between one or more properties of the current track and one or more corresponding properties of the associated potentially subsequent track.

6. A method according to claim 5 wherein the one or more properties of the current track and the one or more corresponding properties of the associated potentially subsequent track comprise metadata associated with the current track and corresponding metadata associated with the associated potentially subsequent track.

7. A method according to claim 6 wherein the metadata associated with the current track comprises one or more of: one or more artists involved in creating the current track; an album on which the current track was released; one or more genres into which the current track may be categorized; a title of the current track; one or more dates associated with the current track; one or more rankings of the current track on one or more corresponding music lists; and membership of the current track on one or more music lists.

8. (canceled)

9. A method according to claim 5 wherein the one or more properties of the current track and the one or more corresponding properties of the associated potentially subsequent track comprise audio data related to the current track and corresponding audio data related to the associated potentially subsequent track.

10. A method according to claim 9 wherein the audio data related to the current track comprises one or more of: temporal length of the current track; one or more rhythmic properties of the current track; one or more timbral properties of the current track; one or more spectral properties of the current track; a bit rate of the current track; an encoding format of the current track; a playback counter associated with the current track; and a last played time stamp associated with the current track.

11. (canceled)

12. A method according to any claim 9 comprising, prior to establishing the one or more selection probabilities corresponding to the current track, analyzing the current track to extract the audio data related to the current track.

13. A method according to claim 5 comprising automatically determining the relative similarity between one or more properties of the current track and the one or more corresponding properties of the associated potentially subsequent track by determining a vector distance between the one or more properties of the current track and the one or more corresponding properties of the associated potentially subsequent track.

14. A method according to claim 13 wherein the vector distance is determined in accordance with at least one of: a Euclidean norm-based vector distance function and a cosine-based vector distance function.

15. A method according to claim 5 comprising automatically determining the relative similarity between one or more properties of the current track and one or more corresponding properties of the associated potentially subsequent track by: training a classifier using a set of training vectors, each training vector comprising concatenated properties of a pair of known audio tracks and using labels of discrete similarity levels for each training vector; continuing training until the classifier develops a set of parameters to map a vector containing concatenated properties of a pair of arbitrary audio tracks to one of the labels of discrete similarity levels; and providing the classifier with a vector comprising concatenated properties of the current track and the associated potentially subsequent track such that the classifier outputs one of the labels of discrete similarity levels.

16. A method according to claim 13 wherein automatically determining the relative similarity between one or more properties of the current track and one or more corresponding properties of the associated potentially subsequent track is performed in response to addition of one or more novel media tracks to the set of accessible media tracks.

17. A method according to claim 5 comprising determining the relative similarity between one or more properties of the current track and one or more corresponding properties of the associated potentially subsequent track comprises obtaining user input relating to at least one of: one or more properties of the current track and one or more corresponding properties of the associated potentially subsequent track.

18. A method according to claim 5 comprising determining the relative similarity between one or more properties of the current track and one or more corresponding properties of the associated potentially subsequent track based, at least in part, on user input.

19. A method according to claim 5 comprising determining the relative similarity between one or more properties of the current track and one or more corresponding properties of the associated potentially subsequent track based, at least in part, on downloading one or more properties of the current track from at least one of: an accessible database; an accessible local area communication network; and the internet.

20. A method according to claim 1 comprising providing a taboo list comprising a list of one or more taboo tracks from among the set of accessible media tracks and wherein selecting the first subsequent track comprises ensuring that the first subsequent track is not one of the one or more taboo tracks.

21. A method according to claim 20 wherein ensuring that the first subsequent track is not one of the one or more taboo tracks comprises selecting an alternate first subsequent track if an originally-selected first subsequent track is one of the one or more taboo tracks.

22. A method according to claim 20 comprising repeating selecting the first subsequent track until the first subsequent track is not one of the one or more taboo tracks.

23. A method according to claim 20 comprising, prior to selecting the first subsequent track, adding the current track to the taboo list.

24. A method according to claim 20 comprising, after selecting the first subsequent track, adding the first subsequent track to the taboo list.

25. A method according to claim 20 comprising removing taboo tracks from the taboo list after at least one of: expiry of a threshold amount of time; and a threshold number of discrete events.

26. A method according to claim 25 wherein each of the discrete events comprises at least one of: completion of playback of a track; commencing playback of a new track; and selection of a subsequent track.

27. A method according to claim 1 comprising playing back the current track and wherein selecting the first subsequent track is performed in response to user input prior to concluding playback of the current media track.

28. A method according to claim 27 comprising, after selecting the first subsequent track, interrupting playback of the current media track to play back the first subsequent media track.

29. (canceled)

30. A method according to claim 1 wherein each of the one or more selection probabilities corresponding to the current track depends, at least in part, on: (i) which of the set of accessible media tracks is provided as the current track; and (ii) the associated potentially subsequent track.

31. A method according to claim 1 wherein selecting the first subsequent track in accordance with the one or more selection probabilities corresponding to the current track comprises generating a pseudo-random number and using the pseudo-random number to select the first subsequent track in accordance with the one or more selection probabilities corresponding to the current track.

32. A method according to claim 1 wherein selecting the first subsequent track in accordance with the one or more selection probabilities corresponding to the current track comprises: assigning one or more non-overlapping domains to the one or more selection probabilities corresponding to the current track, wherein a size of each domain is proportional to its associated selection probability and the non-overlapping domains of the one or more selection probabilities span a domain having a size equal to a sum of the sizes of the adjacent and non-overlapping domains; generating a pseudo-random number in the range; and selecting the first subsequent track corresponding to the non-overlapping domain into which the pseudo-random number is generated.

33. (canceled)

34. A method for establishing a sequence for playback of media tracks from among a set of accessible media tracks, the method comprising:
establishing a plurality of links, each of the plurality of links associating a first track of the accessible media tracks with another one of the accessible media tracks, as a potential next track, each of the plurality of links having a corresponding link strength;
selecting the first track;
selecting a subsequent media track from among the accessible media tracks associated, as potential next tracks, with the first track, wherein selecting the subsequent media track is performed in a probabilistic manner, such that relative link strengths of the plurality of links determine, at least in part, a probability for selecting a particular one of the accessible media tracks associated, as potential next tracks, with the first track to be the subsequent media track.

35. A method according to claim 34 wherein the plurality of links comprises three or more links and wherein the link strengths of the three or more links are all different from one another.

36. A method according to claim 35 wherein the link strengths of the plurality of links are normalized such that the sum of the link strengths of the plurality of the links is unity and the link strengths of the plurality of links are the probabilities for selecting particular ones of the accessible media tracks associated, as potential next tracks, with the first track to be the subsequent media track.

37. A method according to claim 36 wherein establishing the plurality of links comprises, for each of the links: representing one or more properties of the first track as a first vector and one or more properties of another one of the accessible media tracks as a second vector; computing a vector distance between the first and second vectors; and
basing the link strength for the link on the vector distance.

38. A method according to claim 35 wherein establishing the plurality of links comprises:
(a) identifying the first track and another one of the accessible media tracks as a pair of media tracks;
(b) representing one or more properties of first track as a first vector and one or more properties of the other one of the accessible media tracks as a second vector;
(c) computing a vector distance between the first and second vectors; and
(d) basing a link strength for a link between the first track and the other one of the accessible media tracks on the vector distance;
(e) repeating steps (a) through (d) for all of the accessible media tracks except the first track.

39. A method according to claim 38 wherein basing the link strength for the link between the first track and the other one of the accessible media tracks on the vector distance comprises setting the link strength for the link between the first track and the other one of the accessible media tracks to be zero if the vector distance is below a threshold distance.

40. A method according to claim 39 wherein, after repeating steps (a) through (d) for all of the accessible media tracks except the first track, the method comprises, for each of the plurality of links, normalizing the link strength by dividing the link strength for the link by a sum of the link strengths for the plurality of links.

41. A method according to claim 37 wherein the one or more properties of the first track and the one or more properties of the other one of the accessible media tracks comprise metadata associated with the first track and metadata associated with the other one of the accessible media tracks.

42. A method according to claim 41 wherein the metadata associated with the first track comprises one or more of: one or more artists involved in creating the first track; an album on which the first track was released; one or more genres into which the first track may be categorized; a title of the first track; one or more dates associated with the first track; one or more rankings of the first track on one or more corresponding music lists; and membership of the first track on one or more music lists.

43. (canceled)

44. A method according to claim 41 wherein the one or more properties of the first track and the one or more properties of the other one of the accessible media tracks comprise audio data related to the first track and corresponding audio data related to the other one of the accessible media tracks.

45. A method according to claim 44 wherein the audio data related to the first track comprises one or more of: temporal length of the first track; one or more rhythmic properties of the first track; one or more timbral properties of the first track; one or more spectral properties of the first track; a bit rate of the first track; an encoding format of the first track; a playback counter associated with the first track; and a last played time stamp associated with the first track.

46. (canceled)

47. A method according to claim 44 comprising, prior to establishing the plurality of links, analyzing the first track to extract the audio data related to the first track.

48. A method according to claim 39 wherein the vector distance is determined in accordance with at least one of: a Euclidean norm-based vector distance function and a cosine-based vector distance function.

49. A method according to claim 34 comprising automatically determining the relative similarity between one or more properties of the first track and one or more corresponding properties of the other one of the accessible media tracks by: training a classifier using a set training vectors, each training vector comprising concatenated properties of a pair of known audio tracks and using labels of discrete similarity levels for each training vector; continuing training until the classifier develops a set of parameters to map a vector containing concatenated properties of a pair of arbitrary audio tracks to one of the labels of discrete similarity levels; and providing the classifier with a vector comprising concatenated properties of the first track and the other one of the accessible media tracks such that the classifier outputs one of the labels of discrete similarity levels.

50. (canceled)

51. (canceled)

52. A media playback system for playing back media tracks from among a set of accessible media tracks, the media playback system comprising a processor configured to:
recognize a current media track from among the set of media tracks;
access a first plurality of non-zero selection probabilities, each of the first plurality of selection probabilities associated with a corresponding one of a first plurality of media tracks from among the set of media tracks and determining a probability that the corresponding one of the first plurality of media tracks will be selected as a first new media track; and
select the first new media track from among the first plurality of media tracks in accordance with the first plurality of selection probabilities;
wherein each of the first plurality of selection probabilities depends, at least in part, on a relative similarity between one or more properties of the current media track and one or more properties of an individual one of the first plurality of media tracks with which the first selection probability is associated.

53. (canceled)

54. (canceled)

55. A system for media playback comprising:
data storage for holding a set of media tracks;
a media content analyzer for analyzing the media tracks and determining, for each media track, four or more of the following properties: temporal length of the media track; one or more rhythmic properties of the media track; one or more timbral properties of the media track; one or more spectral properties of the media track; a bit rate of the media track; an encoding format of the media track; a playback counter associated with the media track; and a last played time stamp associated with the media track; one or more artists involved in creating the media track; an album on which the media track was released; one or more genres into which the media track may be categorized; a title of the media track; one or more dates associated with the media track; one or more rankings of the media track on one or more corresponding music lists; and membership of the media track on one or more music lists;
a probability assessor for determining a probability of a transition from each media track to each of the other media tracks in the set based, at least in part, on the properties determined by the media content analyzer;
a playlist generator for selecting a sequence of media tracks based at least in part on the probabilities determined by the probability assessor.
